(19) United States
(12) Patent Application Publication
(10) Pub. No.: US 2003/0061054 A1
(43) Pub. Date: Mar. 27, 2003

(54) Speaker independent voice recognition (SIVR) using dynamic assignment of speech contexts, dynamic biasing, and multi-pass parsing

(76) Inventors: Michael J. Payne, Beaverton, OR (US); Karl Allen, Portland, OR (US); Rohan Coelho, Portland, OR (US); Maher M. Hawash, Hillsboro, OR (US)

Correspondence Address: James H. Salter, Blakely, Sokoloff, Taylor & Zafman, Seventh Floor, 12400 Wilshire Boulevard, Los Angeles, CA, 90025-1030, US

(21) Appl. No.: 09/965,052

(22) Filed: Sep. 25, 2001

(51) Int. Cl. G10L 21/00

(52) U.S. Cl. 704/277

(57) ABSTRACT

A method of translating a speech signal into text includes, limiting a language vocabulary to a subset of the language vocabulary, separating the subset into at least two contexts, associating the speech signal with at least one of said at least two contexts, and performing speech recognition within at least one of said at least two contexts, such that the speech signal is translated into text.

### BACKGROUND OF THE INVENTION

1. Field of Invention

This invention is related generally to speaker independent voice recognition (SIVR), and more specifically to speech-enabled applications using dynamic context switching and multi-pass parsing during speech recognition.

2. Art Background

Existing speech recognition engines were designed for use with a large vocabulary. The large vocabulary defines a large search size which requires a user to train the system to minimize the impact of accents. Additional improvement in accuracy is necessary when using the large vocabulary. Therefore, to further improve accuracy of search results, these speech recognition engines require that each session of use be temporarily trained to minimize the impact of session specific background noise.

It is impractical to use an existing speech recognition engine as an acceptable user interface for a speech-enabled application when the engine requires significant training at the beginning of a session. Time spent training is annoying, providing no net benefit to the user. It is also impractical to use an existing speech recognition engine when, despite the time and effort applied to training, the system is rendered unusable when the user has a sore throat. Short command sentences present a phrase to be recognized that is often shorter than the session training phrase, exacerbating an already bothersome problem since the amount of time and effort required to recognize a command is being doubled when the training time is factored in.

The problems with the existing speech recognition engines, mentioned above, have prevented a speech-enabled user interface from becoming a practical alternative to data entry and operation of information displays using short command phrases. True speaker independent voice recognition (SIVR) is needed to make a speech-enabled user interface practical for the user.

Pre-existing SIVR systems like the one marketed by Fluent Technologies, Inc. can only be used with limited vocabularies, typically 200 words or less, in order to keep recognition error rates acceptably low. As the size of a vocabulary increases, the recognition rate of a speech engine decreases, while the time it takes to perform the recognition increases. Some applications for speech-enabled user interfaces require a vocabulary several orders of magnitude larger than the capability of Fluent's engine. Applications can have vocabularies of 2,000 to 20,000 words that must be handled by the SIVR system. Fluent's speech recognition engine is typically applied to recognize short command phrases, with a command word and one or more command parameters. The existing approach to parsing these structured sentences, is to first express the recognition context as a grammar that encompasses all possible permutations and combinations of the command words and their legal parameters. However, with long command sentences and/or with “non-small” vocabularies for the modifying parameters (“data rich” applications), the number of permutations and combinations increases beyond the speech engine's capability of generating unambiguous results. Existing SIVR systems, like the Fluent system discussed herein are inadequate to meet the needs of a speech-enabled user interface coupled to a “data rich” application.

What is needed is a SIVR system that can translate a long command phrase and/or a “non-small” vocabulary for the modifying parameters, with high accuracy in real-time.

### BRIEF DESCRIPTION OF THE DRAWINGS

The present invention is illustrated by way of example and is not limited in the figures of the accompanying drawings, in which like references indicate similar elements.

FIG. 1 illustrates a composition of a language vocabulary in terms of subsets.

FIG. 2 illustrates a relationship between a subset of a language vocabulary, contexts, and a speech signal.

FIG. 3 illustrates multi-pass parsing during speech recognition.

FIG. 4 provides a general system architecture that achieves achieving speaker independent voice recognition.

FIG. 5 is a flow chart for designing a speech-enabled user interface.

FIG. 6 shows a relationship between fields on an application screen and dynamic context switching.

FIG. 7 depicts a system incorporating the present invention in a business setting.

FIG. 8 depicts a handheld device with an information display.

### DETAILED DESCRIPTION

In the following detailed description of embodiments of the invention, reference is made to the accompanying drawings in which like references indicate similar elements, and in which is shown by way of illustration, specific embodiments in which the invention may be practiced. These embodiments are described in sufficient detail to enable those skilled in the art to practice the invention. The following detailed description is, therefore, not to be taken in a limiting sense, and the scope of the invention is defined only by the appended claims.

A system architecture is disclosed for designing a speech-enabled user interface of general applicability to a subset of a language vocabulary. In one or more embodiments, the system architecture, multi-pass parsing, and dynamic context switching are used to achieve speaker independent voice recognition (SIVR) of a speech-enabled user interface. The techniques described herein are generally applicable to a broad spectrum of subject matter within a language vocabulary. The detailed description will flow between the general and the specific. Reference will be made to a medical subject matter during the course of the detailed description, no limitation is implied thereby. Reference is made to the medical subject matter to contrast the general concepts contained within the invention with a specific application to enhance communication of the scope of the invention.

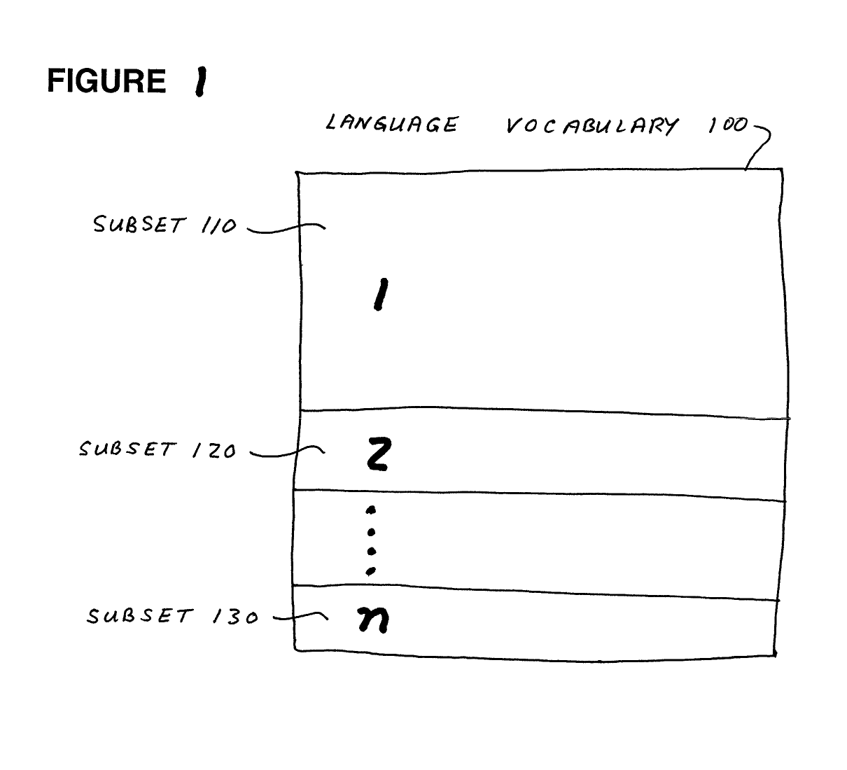

FIG. 1 illustrates the composition of a language vocabulary in terms of subsets. A subset of a language vocabulary, as used herein, refers to a subject matter, such as medicine, banking, accounting, etc. With reference to FIG. 1, a language vocabulary 100 is made up of a general number (n) of subsets. Three subsets are shown to facilitate illustration of the concept, a subset 110, a subset 120, and a subset 130.

A subset may be divided into a plurality of contexts. Contexts may be defined in various ways according to the anticipated design of the speech-enabled user interface. For example, with reference to the medical subject matter, medical usage can be characterized both by a medical application and a medical setting. Examples of medical applications include, prescribing drugs, prescribing a course of treatment, referring a patient to a specialist, dictating notes, ordering lab tests, reviewing a previous patient history, etc. Examples of medical settings include a single physician clinic, a multi-specialty clinic, a small hospital, a department within a large hospital, etc. Consideration is taken of the application and settings to define contexts within the subset of the language vocabulary.

The subset of the language vocabulary is then divided into a number of contexts, previously defined. Dividing the subset into the plurality of contexts achieves the goal of reducing the vocabulary that will be searched by the speech recognition engine. For example, a universe of prescription drugs contains approximately 20,000 individual drugs. Applying the principle of dividing the subset into a plurality of contexts reduces a size of a vocabulary in a given context by one or more orders of magnitude. Recognition of a speech signal is performed within a mini-vocabulary presented by a small number of contexts, even one context, rather than the entire subset of the language vocabulary.

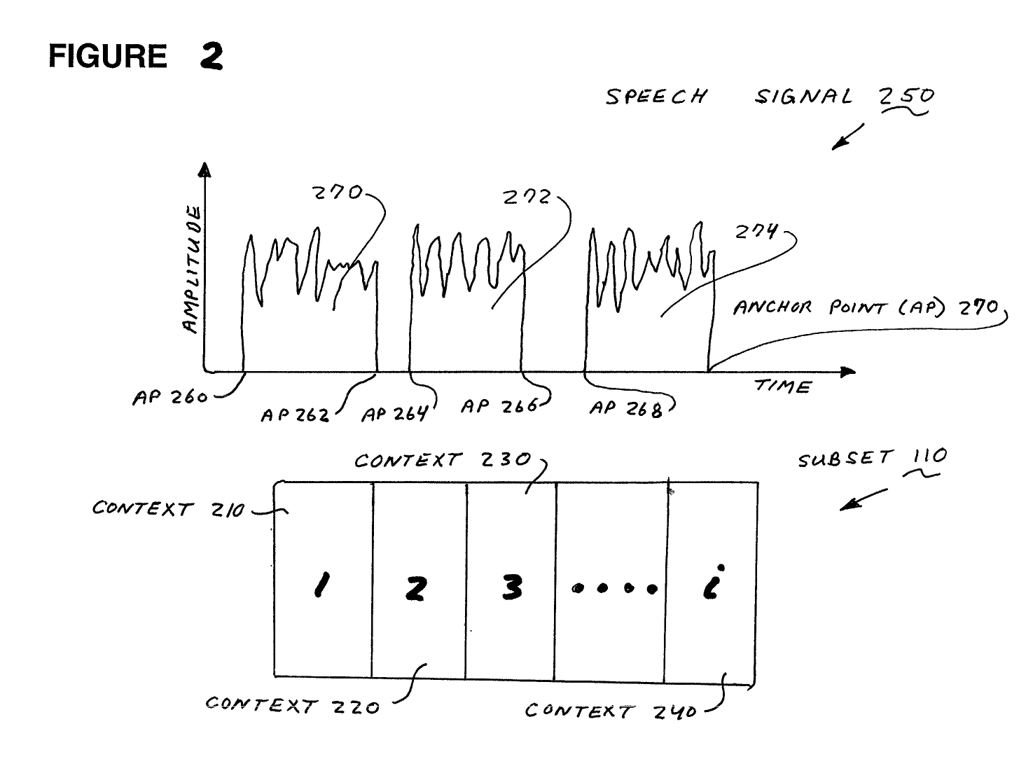

In one embodiment, FIG. 2 illustrates a relationship between a subset of a language vocabulary, contexts, and a speech signal. With reference to FIG. 2, the subset 110 is shown divided into a general number (i) of contexts. Four contexts are shown for ease of illustration, a context 210, a context 220, a context 230, and a context 240. In principle, the number (i) will depend on the size of the speech-enabled user interface. In one embodiment, an amplitude verses time representation of a speech signal 250, input from a speech-enabled user interface, is shown consisting of three parts, a part 270, a part 272 and a part 274. The speech signal 250 is divided into the three parts by searching for and identifying anchor points. Anchor points are pauses or periods of silence, which tend to define the beginning and end of words. In the example of FIG. 2, the part 270 is bounded by an anchor point (AP) 260 and an AP 262. The part 272 is bounded by an AP 264 and an AP 266. Similarly, part 274 is bounded by an AP 268 and an AP 270.

In one embodiment, the part 270 could represent a single word and a speech-enabled application could direct speech recognition to the context 210. In another embodiment, the part 270 could be directed to more than one context for speech recognition, for example the context 210 and the context 220. In yet another embodiment, the parts 270, 272, and 274 could represent words within a command sentence, which is a more complicated speech recognition task. Speech recognition of these parts could be directed to a single context, for example 210.

As part of the process of designing the speech-enabled user interface constraint filters may be defined for an input field within the user interface. In this example, the constraint filters may be applied to the vocabulary set pertaining to the context 210. An example of such a constraint filter is constraining a patient name vocabulary from a universe of all patients in a clinic to only those patients scheduled for a specific physician for a specific day. A second example would be extracting the most frequently prescribed drugs from a physician's prescribing history. Speech recognition bias may be applied to the parts 270, 272, and 274 by using these constraint filters.

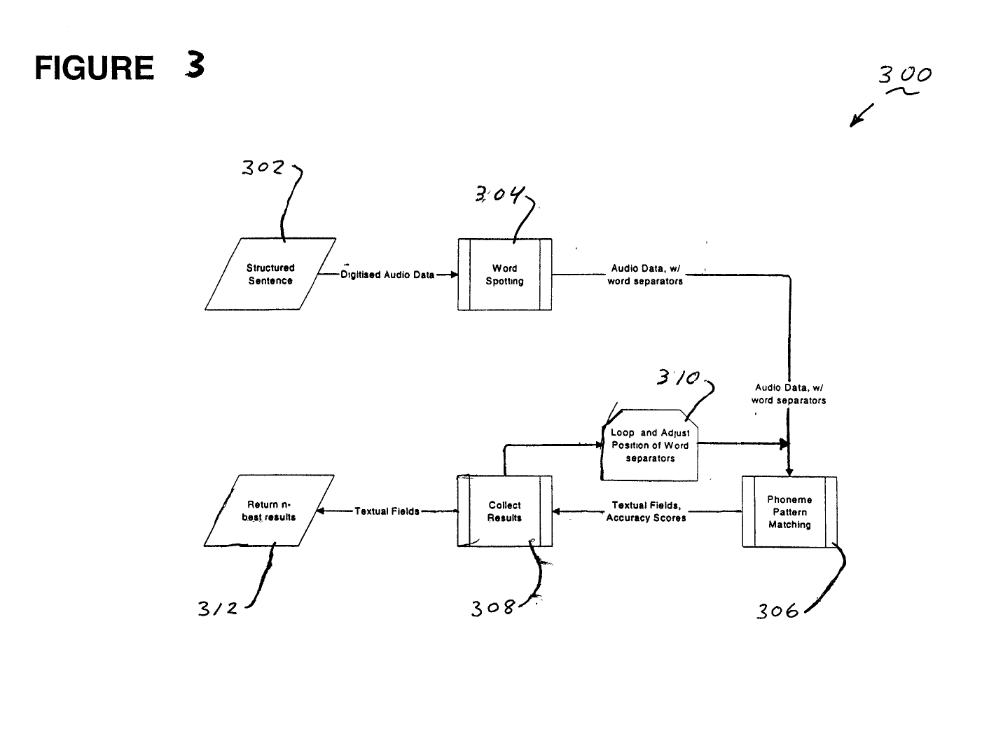

A longer phrase or sentence such as the parts 270, 272, and 274 taken together may present a more difficult recognition task to the speech recognition engine. In one embodiment, a multi-pass parsing methodology is applied to the speech recognition process where long or complex structured sentences exist. FIG. 3 illustrates a flow diagram of multi-pass parsing during speech recognition. The first phase, a word-spotting phase has been described with reference to FIG. 2 where the anchor points were identified. This phase involves looking for pauses in a sentence to generate sets of phonemes that could represent words. With reference to FIG. 3, a structured sentence 302 is digitized (audio data) to create a speech signal. Word spotting at 304 proceeds as described by identifying anchor points in the signal (as described in FIG. 2). The speech engine processes the sets of phonemes at 306. In a second phase, the sets of phonemes are rated for accuracy both as complete words as well as a part of a larger word, results are collected at 308. During the third phase, accuracy ratings are combined and the combination is ranked to create the closest matches. If the results are above a minimum recognition confidence threshold n-best results are then returned at 312. However, if the results have not exceeded the threshold then the system loops back and adjusts the anchor points at 310 and repeats the recognition process until the results exceed the desired recognition threshold.

In one embodiment, the system performs dynamic context switching. Dynamic context switching provides for real-time switching of the context that is being used by the speech engine for recognition. For example, with reference to FIG. 2, the part 270 may require the context 210 for recognition and may pertain to the patient's name context. The part 272 may require context 230 and may pertain to a prescribed medication. Thus, the application will dynamically switch from using context 210 to process the part 270 to use context 230 to process the part 272.

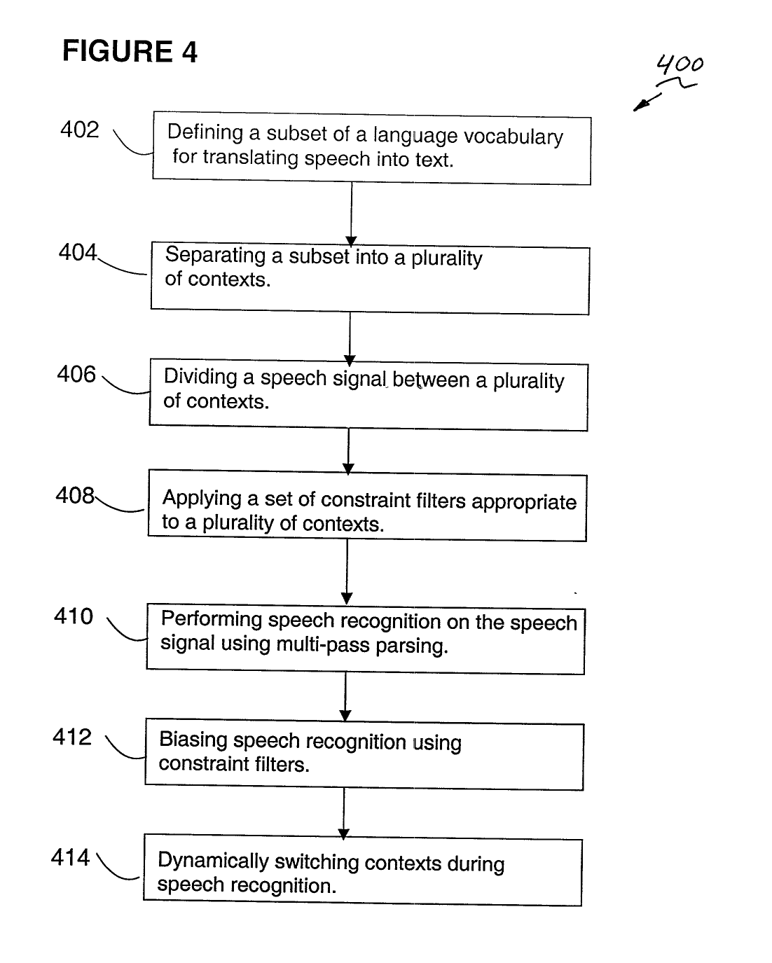

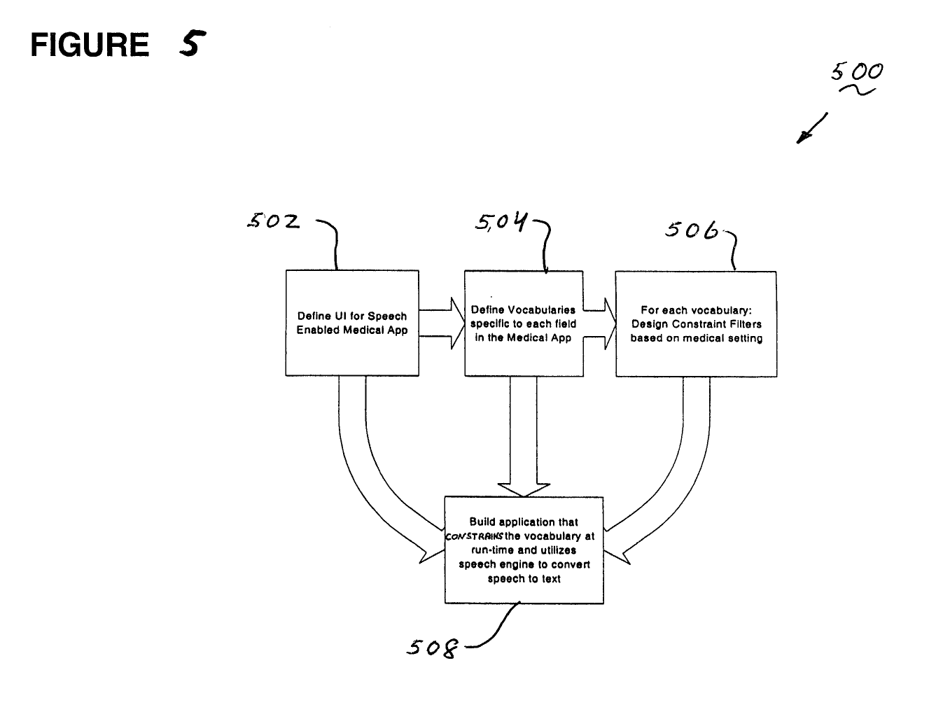

The preceding general description is contained within the block diagram of FIG. 4 at 400. FIG. 4 provides a general system architecture that achieves speaker independent voice recognition by combining the methodology according to the teaching of the invention. A subset of a language vocabulary is defined for translating speech into text at block 402. The subset is separated into a plurality of contexts at block 404. A speech signal is divided between a plurality of contexts at block 406. A set of constraint filters is applied to a plurality of contexts at block 408. Speech recognition is performed on the speech signal using multi-pass parsing at block 410. The speech recognition is biased using constraint filters at block 412. Contexts are dynamically switched during speech recognition at block 414. In various embodiments, the general principles contained in FIG. 4 are applicable to wide variety of subject matter as previously discussed. These general principles may be used to design applications using a speech-enabled user interface. In one embodiment, FIG. 5 illustrates a flow chart depicting a process for building a speech-enabled user interface for a medical application. With reference to FIG. 5, a user interface for a speech enabled medical application is defined at block 502. Block 502 includes designing screens for the medical application and speech-enabled input fields. A vocabulary associated with each input field is defined at block 504. The associated constraint filters are defined at block 506 for the medical setting. Blocks 502, 504, and 506 come together at block 508 to provide an application that constrains the language vocabulary during run-time of the application, utilizing the speech engine to convert speech to text independent of the speaker's voice. In one embodiment, the present invention is producing 95% accurate identification of speech with vocabularies of over 2,000 words. This is a factor of 10 improvement in vocabulary size, for the same accuracy rating, over existing speech identification techniques that do not utilize the teachings of the present invention.

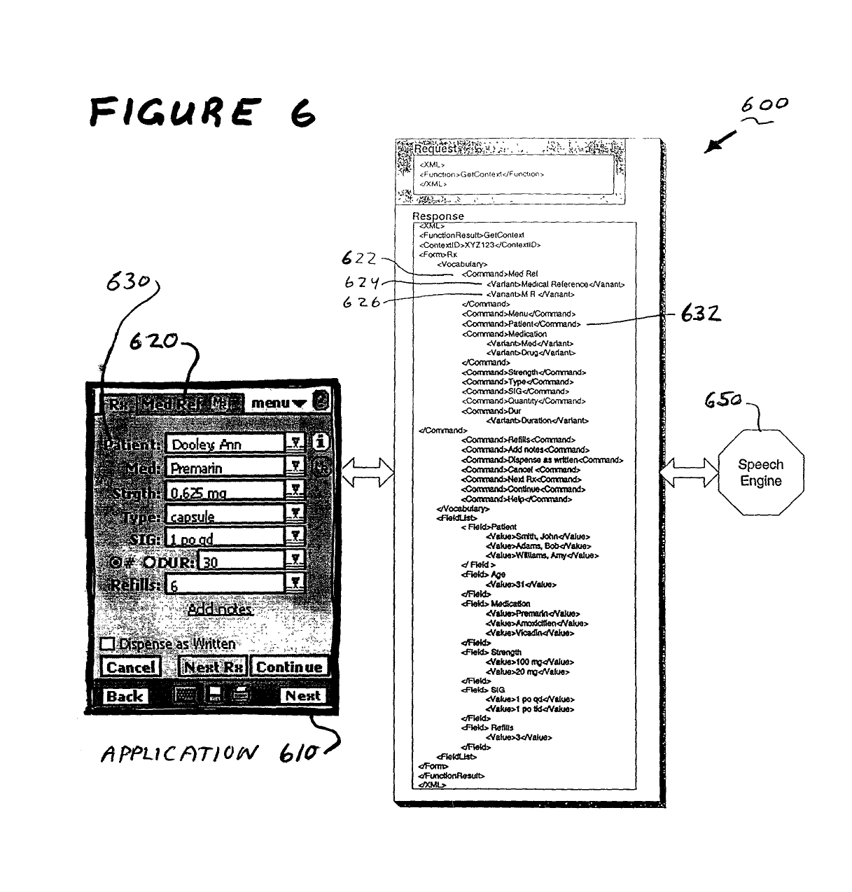

Dynamic context switching has been described earlier with reference to FIG. 2. In one embodiment, FIG. 6 shows a relationship between fields on an application screen and dynamic context switching. With reference to FIG. 6, a screen of an application is shown at 610. A “Med Ref” speech-enabled entry field is shown at 620. A command that directs control to a context associated with 620 is shown at 622. A type of “mini-context” for words that are also allowed to direct control are shown with entries 624 and 626. The result of this mini-context definition is that the application will only respond by directing control to the “Med Ref” context if one of the mini-context entries is recognized. 624 allows “Medical Reference” and 626 allows “M.R.” to be used to direct control to the context associated with the medical reference for drugs within the medical application. Speech engine 650 will process the speech signal input from the application 610 according to the context selected for the speech signal, thus reducing the size of the vocabulary that must be searched in order to perform the speech recognition.

Thus, dynamic context switching allows any speech-enabled application to set a “current vocabulary context” of the speech engine to a limited dictionary of words/phrases to choose from as it tries to recognize the speech. Effectively, the application restricts the speech engine to a set of words that may be accepted from the user, which increases the recognition rate. This protocol allows the application to set the current vocabulary context for the entire application, and/or for a specific state (per dialogue/screen).

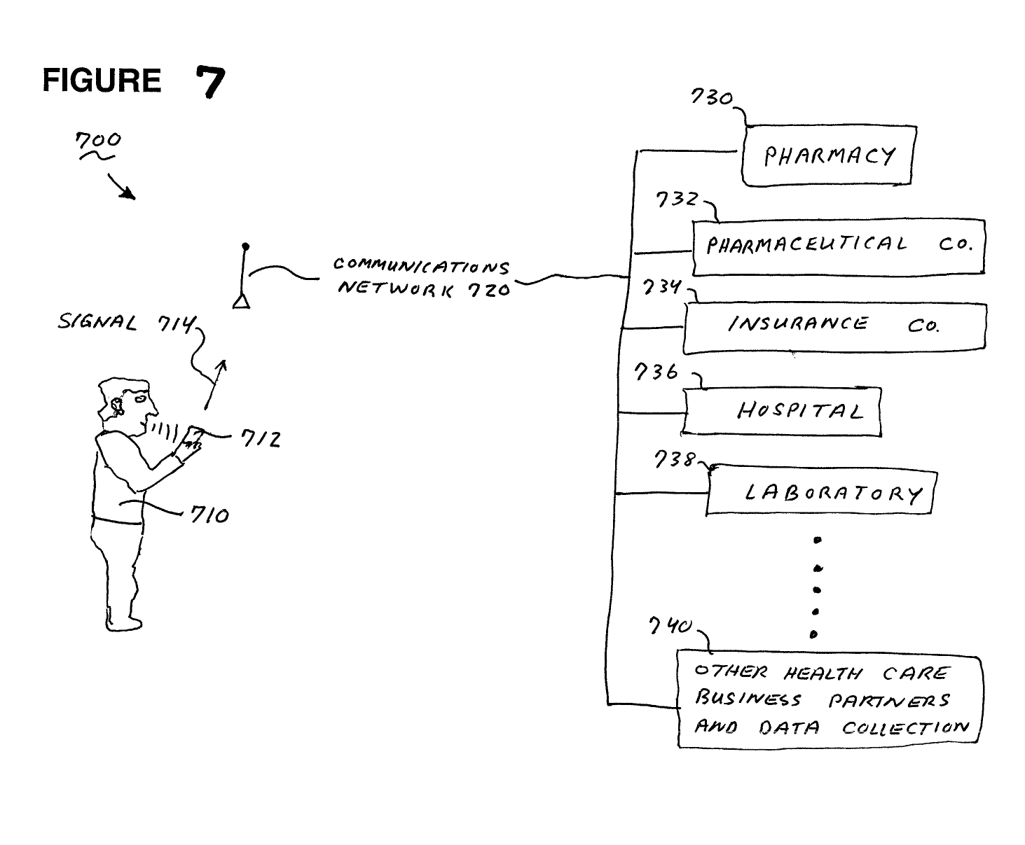

It is anticipated that the present invention will find broad application to many and varied subject matter as previously discussed. In one embodiment, FIG. 7 depicts a system 700 incorporating the present invention in a medical business setting. The example used in this description allows a physician 710, while examining a patient, to connect and get information from health care business partners e.g., a pharmacy 730, a pharmaceutical company 732, an insurance company 734, a hospital 736, a laboratory 738, or other health care business partner and data collection center at 740. The invention provides retrieval of information in real-time via a communications network 720, which may be an end-to-end Internet based infrastructure using a handheld device 712 at the point of care. In one embodiment, the handheld device 712 communicates with communication network 720 via wireless signal 714. The level of medical care rendered to the patient (fully informed decisions by treating physician) and the efficiency of delivery of the medical care is enhanced by the present invention since the relevant information on the patient being treated is available to the treating physician in real-time.

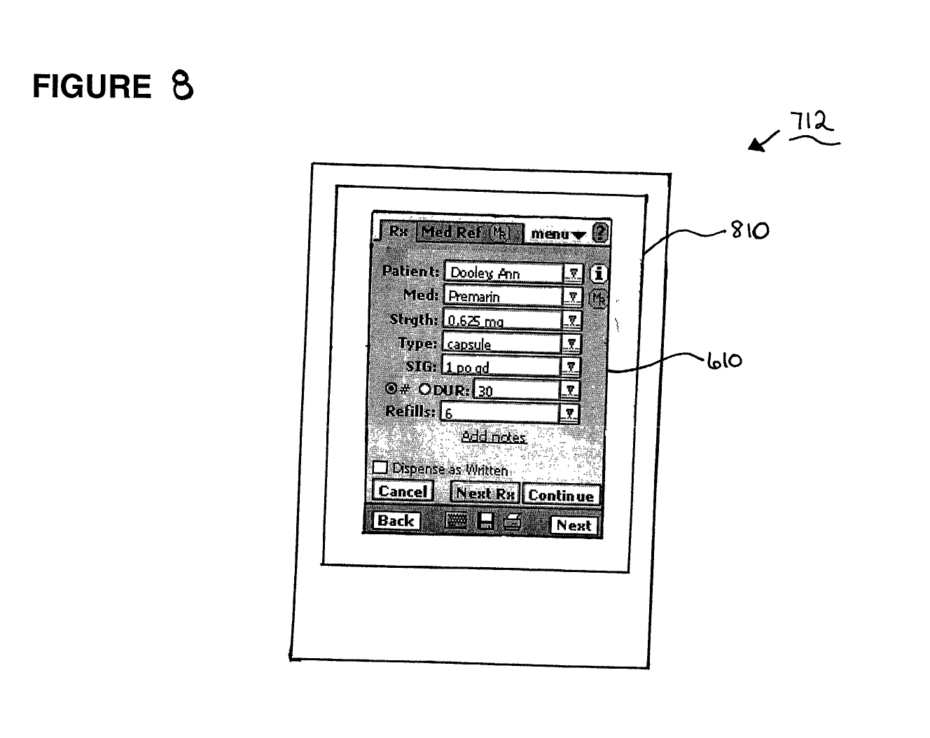

In one embodiment, incorporating an information display configured to display an application screen is shown in FIG. 8. Handheld device 712 with an information display 810 may be configured to communicate with communication network 720 as previously described.

Many other business applications are contemplated. A nonexclusive list includes business entities such as an automotive company, a financial services company, a bank, an investment company, an accounting firm, a law firm, a grocery company, and a restaurant services company. In one embodiment, a business entity will receive the signal resulting from the speech recognition process according to the teachings of the present invention. In one embodiment, the user of the speech-enabled user interface will be able to interact with the business entity using the handheld device with voice as the primary input method. In another embodiment, a vehicle, such as a car, truck, boat or air plane, may be equipped with the present invention allowing the user to make reservations at a hotel or restaurant or order a take-out meal instead. In another embodiment, the present invention may be an interface within a computer (mobile or stationary).

It will be appreciated that the methods described in conjunction with the figures may be embodied in machine-executable instructions, e.g. software. The instructions can be used to cause a general-purpose or special-purpose processor that is programmed with the instructions to perform the operations described. Alternatively, the operations might be performed by specific hardware components that contain hardwired logic for performing the operations, or by any combination of programmed computer components and custom hardware components. The methods may be provided as a computer program product that may include a machine-readable medium having stored thereon instructions which may be used to program a computer (or other electronic devices) to perform the methods. For the purposes of this specification, the terms “machine-readable medium” shall be taken to include any medium that is capable of storing or encoding a sequence of instructions for execution by the machine and that cause the machine to perform any one of the methodologies of the present invention. The term “machine-readable medium” shall accordingly be taken to included, but not be limited to, solid-state memories, optical and magnetic disks, and carrier wave signals. Furthermore, it is common in the art to speak of software, in one form or another (e.g., program, procedure, process, application, module, logic . . . ), as taking an action or causing a result. Such expressions are merely a shorthand way of saying that execution of the software by a computer causes the processor of the computer to perform an action or produce a result.

Thus, a novel speaker independent voice recognition system (SIVR) is described. Although the invention is described herein with reference to specific preferred embodiments, many modifications therein will readily occur to those of ordinary skill in the art. Accordingly, all such variations and modifications are included within the intended scope of the invention as defined by the following claims.

What is claimed is:

1. A method to translate a speech signal into text, comprising:
limiting a language vocabulary to a subset of the language vocabulary;
separating said subset into at least two contexts;
associating the speech signal with at least one of said at least two contexts; and
performing speech recognition within at least one of said at least two contexts, such that the speech signal is translated into text.

2. Said method of claim 1, further comprising:
applying a constraint filter to at least one context of said at least two contexts to restrict a size of said subset associated with said at least one context.

3. Said method of claim 2, wherein said constraint filter is at least one of a set of patients and a set of frequently prescribed drugs.

4. Said method of claim 2, wherein said performing speech recognition is biased using said constraint filter.

5. Said method of claim 1, wherein said subset is selected from the group consisting of a medical subset, an automotive subset, a construction subset, and an educational subset.

6. A method of designing a speaker independent voice recognition (SIVR) speech-enabled (SE) user interface (UI), comprising:
defining a subject matter to base the UI on;
designating a first allowable vocabulary for a first SE field of the UI;
designating a second allowable vocabulary for a second SE field of the UI; and
designing a constraint filter for at least one of said first allowable vocabulary and said second allowable vocabulary.

7. Said method of claim 6, wherein said subject matter is a medical subject matter.

8. Said method of claim 7, wherein said medical subject matter is characterized by at least one of; a medical application, and a medical setting.

9. A method of translating a speech signal into text, comprising:
identifying at least two anchor points in an audio signal record, wherein a segment of the audio signal is contained between the at least two anchor points;
generating sets of phonemes, using a subset of a language vocabulary, that correspond to the segment of the audio signal contained between the at least two anchor points;
rating the sets of phonemes for accuracy as an individual word and as a part of a larger word;
combining accuracy ratings from said rating;
ranking the sets of phonemes according to said rating; and
selecting the word or part of the word corresponding to the segment of the audio signal contained between the at least two anchor points.

10. Said method of claim 9, wherein said subset of the language vocabulary is separated into a plurality of contexts and said generating is performed within a context of the plurality of contexts.

11. Said method of claim 10, wherein the context is dynamically changed during said generating.

12. Said method of claim 9, further comprising identifying a new anchor point, such that said generating is performed on a segment of the audio signal defined with the new anchor point.

13. A speech translation method, comprising:
generating a first phoneme from a first audio signal using a first context of a language vocabulary;
switching said first context to a second context; and
generating a second phoneme from a second audio signal using said second context of the language vocabulary.

14. Said method of claim 13, wherein real-time speech translation is maintained.

15. A speech translation method, comprising:
generating a first phoneme from an audio signal using a first context of a language vocabulary;
generating a second phoneme from the audio signal using a second context of the language vocabulary; and
selecting a word or part of a word from the first phoneme and the second phoneme that represents a translation of the audio signal.

16. Said method of claim 15, wherein real-time speech translation is maintained.

17. Said method of claim 15, wherein said first context is switched to said second context before said generating the second phoneme.

18. A computer readable medium containing executable computer program instructions, which when executed by a data processing system, cause the data processing system to perform a method to translate a speech signal into text, comprising:
limiting a language vocabulary to a subset of the language vocabulary;
separating said subset into at least two contexts;
associating the speech signal with at least one of said at least two contexts; and
performing speech recognition within at least one of said at least two contexts, such that the speech signal is translated into text.

19. The computer readable medium as set forth in claim 18, wherein the method further comprises;
applying a constraint filter to at least one context of said at least two contexts to restrict a size of said subset associated with said at least one context.

20. The computer readable medium as set forth in claim 19, wherein said constraint filter is at least one of a set of patients, and a set of frequently prescribed drugs.

21. The computer readable medium as set forth in claim 18, wherein said performing speech recognition is biased using said constraint filter.

22. The computer readable medium as set forth in claim 18, wherein said subset is selected from the group consisting of a medical subset, an automotive subset, a construction subset, and an educational subset.

23. A computer readable medium containing executable computer program instructions, which when executed by a data processing system, cause the data processing system to perform a method of designing a speaker independent voice recognition (SIVR) speech-enabled (SE) user interface (UI) comprising:
defining a subject matter to base the UI on;
designating a first allowable vocabulary for a first SE field of the UI;
designating a second allowable vocabulary for a second SE field of the UI; and
designing a constraint filter for at least one of said first allowable vocabulary and said second allowable vocabulary.

24. The computer readable medium as set forth in claim 23, wherein said subject matter is a medical subject matter.

25. The computer readable medium as set forth in claim 24, wherein said medical subject matter is characterized by at least one of; a medical application, and a medical setting.

26. A computer readable medium containing executable computer program instructions, which when executed by a data processing system, cause the data processing system to perform a method of translating a speech signal into text comprising:
identifying at least two anchor points in an audio signal record, wherein a segment of the audio signal is contained between the at least two anchor points;
generating sets of phonemes, using a subset of a language vocabulary, that correspond to the segment of the audio signal contained between the at least two anchor points;
rating the sets of phonemes for accuracy as an individual word and as a part of a larger word;
combining accuracy ratings from said rating;
ranking the sets of phonemes according to said rating; and
selecting the word or part of the word corresponding to the segment of the audio signal contained between the at least two anchor points.

27. The computer readable medium as set forth in claim 26, wherein the subset of the language vocabulary is separated into a plurality of contexts and said generating is performed within a context of the plurality of contexts.

28. The computer readable medium as set forth in claim 27, wherein the context is dynamically changed during said generating.

29. The computer readable medium as set forth in claim 26, wherein the method further comprises identifying a new anchor point, such that said generating is performed on a segment of the audio signal defined with the new anchor point.

30. A computer readable medium containing executable computer program instructions, which when executed by a data processing system, cause the data processing system to perform a speech translation method comprising:
generating a first phoneme from a first audio signal using a first context of a language vocabulary;
switching said first context to a second context; and
generating a second phoneme from a second audio signal using said second context of the language vocabulary.

31. The computer readable medium as set forth in claim 30, wherein real-time speech translation is maintained.

32. A computer readable medium containing executable computer program instructions, which when executed by a data processing system, cause the data processing system to perform a speech translation method comprising:
generating a first phoneme from an audio signal using a first context of a language vocabulary;
generating a second phoneme from the audio signal using a second context of the language vocabulary; and
selecting a word or part of a word from the first phoneme and the second phoneme that represents a translation of the audio signal.

33. The computer readable medium as set forth in claim 32, wherein real-time speech translation is maintained.

34. The computer readable medium as set forth in claim 32, wherein said first context is switched to said second context before said generating the second phoneme.

35. An apparatus to translate a speech signal into text comprising:
a processor to receive the speech signal;
a memory coupled with said processor; and
a computer readable medium containing executable computer program instructions, which when executed by said apparatus, cause said apparatus to perform a method:
limiting a language vocabulary to a subset of the language vocabulary;
separating said subset into at least two contexts;
associating the speech signal with at least one of said at least two contexts; and
performing speech recognition within at least one of said at least two contexts, such that the speech signal is translated into the text.

36. Said apparatus of claim 35, further comprising an information display to display the text resulting from translation of the speech signal.

37. Said apparatus of claim 35, further comprising a wireless interface to allow communication of at least one of the speech signal and the text.

38. Said apparatus of claim 35, wherein said apparatus is at least one of hand held, and installed in a vehicle.

39. Said apparatus of claim 35, wherein said apparatus to communicate with the Internet.

40. An apparatus comprising:
a signal embodied in a propagation medium, wherein said signal results from generating a first phoneme from an audio signal using a first context of a language vocabulary and switching the first context to a second context and generating a second phoneme from the audio signal using the second context of the language vocabulary.

41. Said apparatus of claim 40, further comprising:
a business entity, said business entity being at least one of a pharmacy, a pharmaceutical company, a hospital, an insurance company, a user defined health care partner, a laboratory, an automotive company, a financial services company, a bank, an investment company, an accounting firm, a law firm, a grocery company, and a restaurant services company, wherein said business entity to receive said signal.

42. An apparatus comprising:
an information transmission system to receive and convey a signal, wherein said signal results from generating a first phoneme from an audio signal using a first context of a language vocabulary and switching the first context to a second context and generating a second phoneme from the audio signal using the second context of the language vocabulary.

43. Said apparatus of claim 42, further comprising:
a business entity, said business entity being at least one of; a pharmacy, a pharmaceutical company, a hospital, an insurance company, a user defined health care partner, a laboratory, an automotive company, a financial services company, a bank, an investment company, an accounting firm, a law firm, a grocery company, and a restaurant services company, wherein said business entity to receive said signal from said information transmission system.

44. An apparatus comprising:
a signal embodied in a propagation medium, wherein said signal results from limiting a language vocabulary to a subset of the language vocabulary, separating said subset into at least two of contexts, associating the speech signal with at least one of said at least two contexts, and performing speech recognition within at lease one of said at least two contexts, such that the speech signal is translated into text.

45. Said apparatus of claim 44, further comprising:
a business entity, said business entity being at least one of; a pharmacy, a pharmaceutical company, a hospital, an insurance company, a user defined health care partner, a laboratory, an automotive company, a financial services company, a bank, an investment company, an accounting firm, a law firm, a grocery company, and a restaurant services company, wherein said business entity to receive said signal.

46. An apparatus comprising:
an information transmission system to receive and convey a signal, wherein said signal results from limiting a language vocabulary to a subset of the language vocabulary, separating said subset into at least two contexts, associating the speech signal with at least one of said at least two contexts, and performing voice recognition within at least one of said at least two contexts, such that the speech signal is translated into text.

47. Said apparatus of claim 46, further comprising:
a business entity, said business entity being at least one of; a pharmacy, a pharmaceutical company, a hospital, an insurance company, a user defined health care partner, a laboratory, an automotive company, a financial services company, a bank, an investment company, an accounting firm, a law firm, a grocery company, and a restaurant services company, wherein said business entity to receive said signal from said information transmission system.
